(19) United States
(12) Patent Application Publication
(10) Pub. No.: US 2008/0240769 A1
(43) Pub. Date: Oct. 2, 2008

(54) IMAGE FORMING APPARATUS

(75) Inventors: Kotaro Kawasaki, Osaka-shi (JP); Youhei Noguchi, Osaka-shi (JP)

Correspondence Address: CASELLA & HESPOS, 274 MADISON AVENUE, NEW YORK, NY, 10016, US

(73) Assignee: Kyocera Mita Corporation, Osaka-shi (JP)

(21) Appl. No.: 12/056,534

(22) Filed: Mar. 27, 2008

(30) Foreign Application Priority Data
Mar. 30, 2007 (JP) 2007-091979

(51) Int. Cl. G03G 21/20

(52) U.S. Cl. 399/92

(57) ABSTRACT

An image forming apparatus is provided with an image forming unit for applying an image transferring process to a sheet-like recording material, a fixing unit for applying a heat fixing process to the recording material after the image transferring process by the image forming unit, a first conveyance path for conveying the recording material via the image forming unit and the fixing unit, a second conveyance path for returning the recording material after the fixing process by the fixing unit to an upstream side of the image forming unit from a side of the first conveyance path downstream of the fixing unit in the case of applying the image transferring process to both sides of the recording material, and a fan disposed between the first and second conveyance paths for taking air across the first conveyance path and exhausting air across the second conveyance path to form an air stream.

### BACKGROUND OF THE INVENTION

1. Field of the Invention

The present invention relates to an image forming apparatus provided with two conveyance paths for recording materials for simple printing and duplex printing.

2. Description of the Related Art

Conventional image forming apparatuses such as facsimile machines and copiers are provided with two conveyance paths for conveying recording sheets (recording materials), i.e. a first conveyance path for simple printing and a second conveyance path for duplex printing, in many cases. An image forming unit for transferring a toner image to a recording sheet being conveyed in the first conveyance path and a fixing unit for fixing the toner image to the recording sheet by applying heat to the toner image are provided at intermediate positions of the first conveyance path, the fixing unit being located downstream of the image forming unit. At the time of printing only one side of a recording sheet, the recording sheet is introduced to the image forming unit and the fixing unit only once along this first conveyance path to form an image only on one side of the recording sheet. On the other hand, at the time of duplex printing, a recording sheet having an image formed on one side thereof as described above is conveyed along the second conveyance path from a position of the first conveyance path downstream of the fixing unit to a position upstream of the image forming unit, thereby being introduced to the first conveyance path again. The recording sheet is introduced to the first conveyance path again in this way to have an image formed on the other side thereof.

Japanese Unexamined Patent Publication No. H07-239647 discloses a construction for detecting the temperature of a recording sheet heated by a fixing process after the recording sheet is fixed by a fixing unit in the first image forming operation at the time of duplex printing. If the detected temperature is higher than a specified temperature, a fan commonly used for the respective parts of the image forming apparatus is driven to cool the respective parts.

On the other hand, Japanese Unexamined Patent Publication No. 2000-304395 discloses a special fan exclusively used for a second conveyance path and a construction for cooling by blowing air to the main part of the second conveyance path and to a conveyance motor for the second conveyance path disposed in the vicinity of the second conveyance path from the special fan.

However, technology disclosed in Japanese Unexamined Patent Publication No. H07-239647 uses the common fan and has a problem of being unable to sufficiently cool a hot recording sheet. Further, technology disclosed in Japanese Unexamined Patent Publication No. 2000-304395 cannot exhibit a significant performance improvement worth the cost of providing the fan since the special fan for the second conveyance path for cooling only the vicinity of the second conveyance path is used.

On the other hand, image forming apparatuses have had a problem that a recording sheet being conveyed in the first conveyance path is, for example, lifted from the conveyance path to make its behavior unstable.

### SUMMARY OF THE INVENTION

An object of the present invention is to provide an image forming apparatus capable of sufficiently cooling a recording material having reached a high temperature by an image forming operation on one side thereof at the time of duplex printing and stabilizing the behavior of the recording material being conveyed in a first conveyance path.

One aspect of the present invention is directed to an image forming apparatus, comprising an image forming unit for applying an image transferring process to a sheet-like recording material; a fixing unit for applying a heat fixing process to the recording material after the image transferring process by the image forming unit; a first conveyance path for conveying the recording material via the image forming unit and the fixing unit; a second conveyance path for returning the recording material after the fixing process by the fixing unit to an upstream side of the image forming unit from a side of the first conveyance path downstream of the fixing unit in the case of applying the image transferring process to both sides of the recording material; and a fan disposed between the first and second conveyance paths for taking air across the first conveyance path and exhausting air across the second conveyance path to form an air stream.

### BRIEF DESCRIPTION OF THE DRAWINGS

FIG. 1 is a perspective view showing the external appearance of an image forming apparatus according to one embodiment of the invention,

FIG. 2 is a section showing the internal construction of an apparatus main body of the image forming apparatus,

FIG. 3 is a section enlargedly showing an essential part of FIG. 2,

FIG. 4 is a side view of the image forming apparatus, and

FIG. 5 is a diagram enlargedly showing an essential part of FIG. 4.

### DETAILED DESCRIPTION OF THE PREFERRED EMBODIMENTS

Hereinafter, one embodiment of the present invention is described in detail with reference to the accompanying drawings.

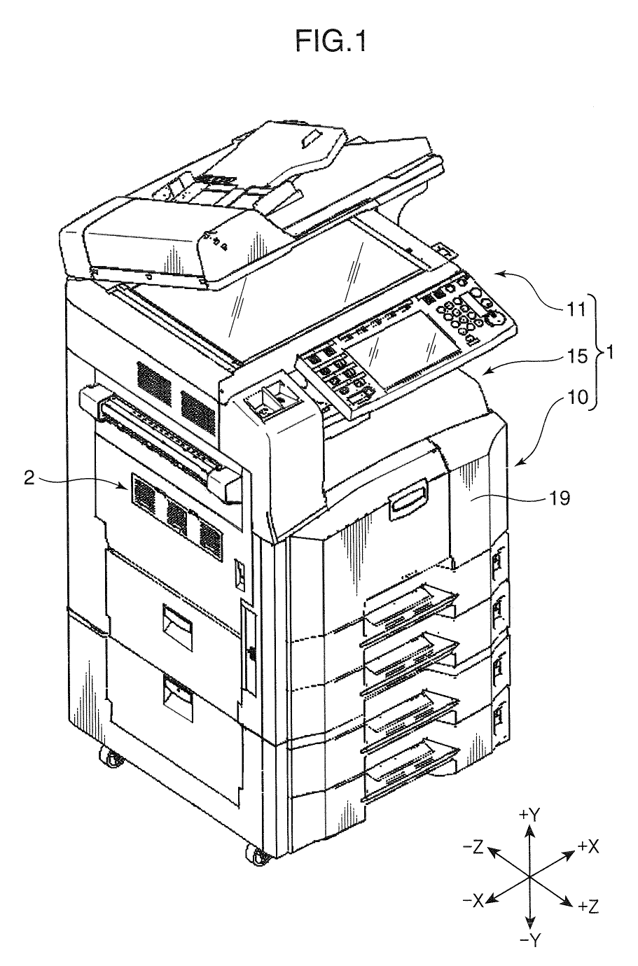

FIG. 1 is a perspective view showing the external appearance of an image forming apparatus 1 according to one embodiment of the invention. The image forming apparatus 1 is a copier of the so-called internal discharge type provided with an apparatus main body 10, a scanner unit 11 arranged atop the apparatus main body 10 and a discharge unit 15 arranged between the apparatus main body 10 and the scanner unit 11.

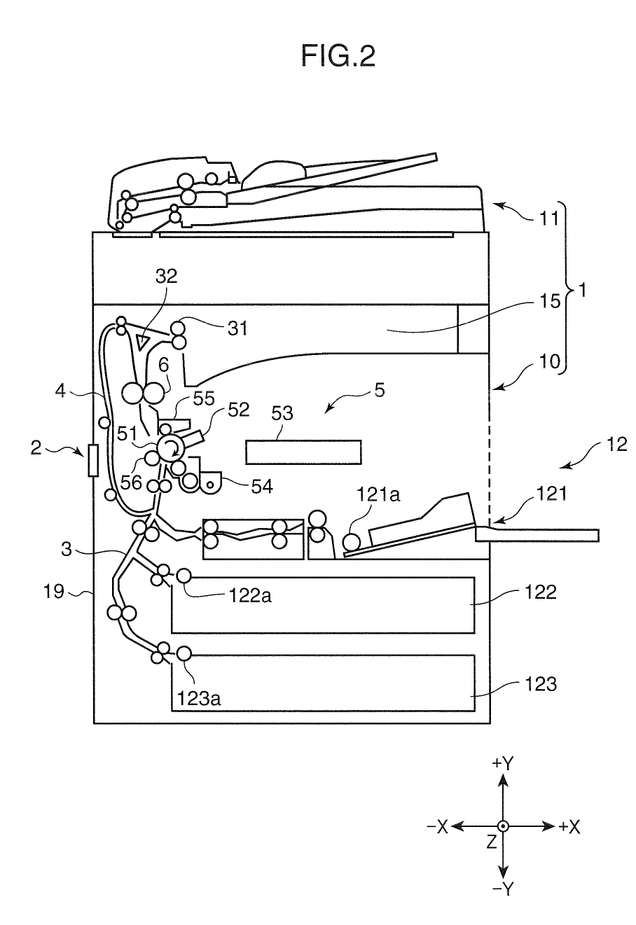

Various mechanisms used for image formation are accommodated in the apparatus main body 10 (to be described later with reference to FIG. 2). An outer covering 19 of the image forming apparatus 10 constitutes the outer body of the apparatus main body 10 and functions as a casing for accommodating various mechanisms of the apparatus main body 10 used for image formation. A plurality of sheet cassettes (see sheet cassettes 122, 123 shown in FIG. 2) are detachably attached at the front surface (facing in +Z direction in FIG. 1) of the apparatus main body 10. An exhaust ventilator 2 is formed on a side surface of the apparatus main body 10 facing in −X direction in FIG. 1.

The scanner unit 11 reads a document image of a document set in the scanner unit 11. The scanner unit 11 reads only a document image on the top side of a document when simplex printing of copying only the document image on the top side of the document on a recording sheet (sheet-like recording material) is performed in the image forming apparatus 1. On the other hand, the scanner unit 11 reads document image on both top and under sides of a set document when duplex printing of copying the document images on the top and under sides of the document on the top and under sides of a recording sheet is performed in the image forming apparatus 1.

The discharge unit 15 is a part to which a recording sheet fed from the sheet cassette 122, 123 or a manual sheet feeder 121 (see FIG. 2) is discharged after an image forming process is applied thereto in the apparatus main body 10.

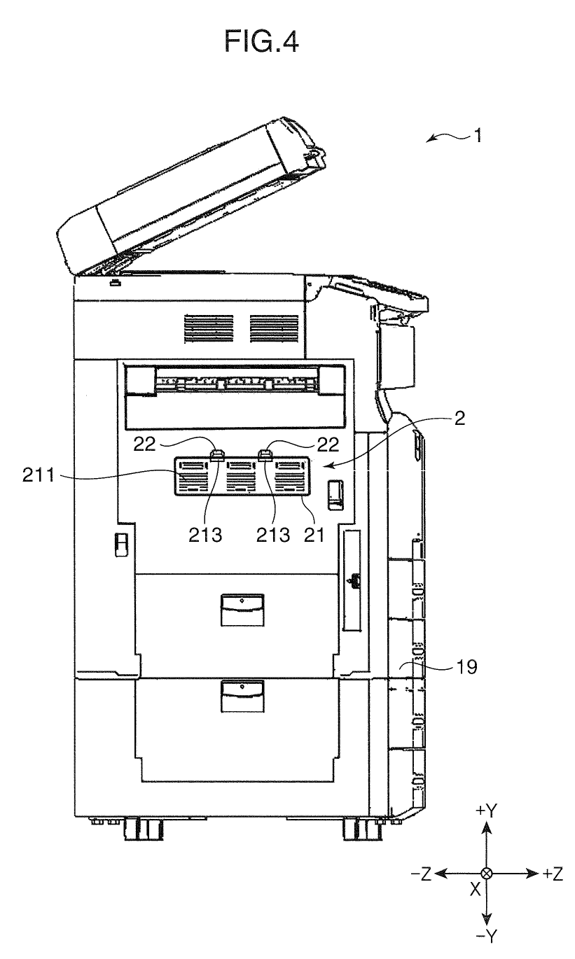

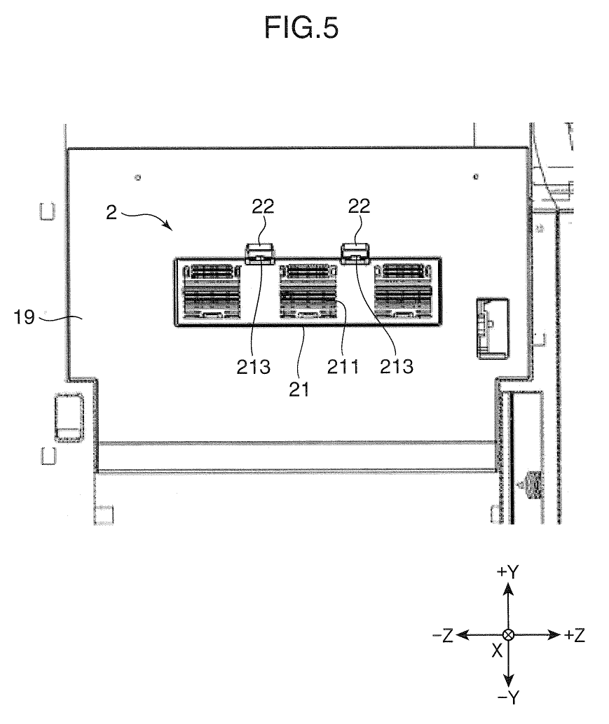

The exhaust ventilator 2 exhausts hot air in the apparatus main body 10 heated by performing the image forming operation in the apparatus main body 10 to the outside of the image forming apparatus 1 through exhaust holes 211 (see FIGS. 4 and 5) of the exhaust ventilator 2.

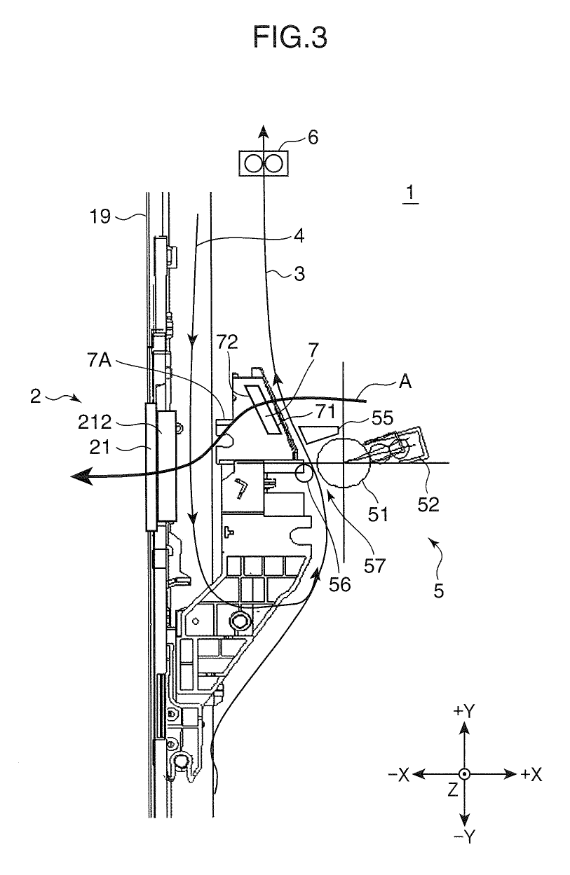

FIG. 2 is a section showing the internal construction of the apparatus main body 10, and FIG. 3 is a section enlargedly showing an essential part of FIG. 2. With reference to FIGS. 2 and 3, the internal construction of the apparatus main body 10 is described. The apparatus main body 10 includes a simplex printing conveyance path 3 (first conveyance path), a duplex printing conveyance path 4 (second conveyance path), a sheet feeding unit 12, an image forming unit 5, a fixing unit 6 and a pair of discharge rollers 31.

The sheet feeding unit 12 includes the sheet cassettes 122, 123 accommodating recording sheets having different sizes, different vertical and horizontal orientations and the manual sheet feeder 121. Each sheet cassette 122, 123 has a pickup roller 122a, 123a for dispensing the recording sheets accommodated therein one by one and feeding them to a lower part of the simplex printing conveyance path 3. The manual sheet feeder 121 likewise has a pickup roller 121a for dispensing recording sheets placed thereon one by one and feeding them to the lower part of the simplex printing conveyance path 3. The recording sheets in and on the respective sheet cassettes 122, 123 and manual sheet feeder 121 are introduced to the simplex printing conveyance path 3 by driving these pickup rollers 122a, 123a and 121a.

The lower part of the simplex printing conveyance path 3 is connected with the sheet cassettes 122, 123 and the manual sheet feeder 121 of the sheet feeding unit 12. The simplex printing conveyance path 3 extends substantially vertically upward from its part connected with the sheet feeding unit 12 to the discharge unit 15. The recording sheet from any one of the sheet cassettes 122, 123 and the manual sheet feeder 121 is introduced to the lower part of the simplex printing conveyance path 3 connected with the sheet feeding unit 12. The introduced recording sheet is conveyed upward to the discharge unit 15 along the simplex printing conveyance path 3. The image forming unit 5 and the fixing unit 6 are successively disposed in a conveying direction of the recording sheet on the simplex printing conveyance path 3.

The image forming unit 5 transfers a toner image of a document image to a recording sheet conveyed thereto along the simplex printing conveyance path 3. The image forming unit 5 includes a photoconductive drum 51, a charger 52, a laser emitter 53, a developing device 54, a cleaning unit 55 and a transfer roller 56.

The photoconductive drum 51 rotates about its axis of rotation and bears an electrostatic latent image and a toner image of a document image on its circumferential surface. The charger 52 applies a high voltage to the photoconductive drum 51 to uniformly charge the circumferential surface of the photoconductive drum 51. The laser emitter 53 irradiates the charged circumferential surface of the photoconductive drum 51 with a laser beam corresponding to the image data of the document image read by the scanner unit 11 to form an electrostatic latent image of the document image on the circumferential surface of the photoconductive drum 51. The developing device 54 develops the electrostatic latent image to form a toner image corresponding to the document image on the circumferential surface of the photoconductive drum 51. The transfer roller 56 forms a nip portion 57 together with the photoconductive drum 51 to transfer the toner image to the recording sheet. The cleaning unit 55 removes toner residual on the circumferential surface of the photoconductive drum 51 after the transfer of the toner image. The recording sheet has the toner image transferred thereto in the nip portion 57 while being conveyed in the simplex printing conveyance path 3.

Here, when the charger 52 charges the photoconductive drum 51, ozone is sometimes produced from the charger 52 since a high voltage is applied to the charger 52. If such ozone is adsorbed by the photoconductive drum 51, a surface potential defect of the photoconductive drum 51 might occur. Thus, it is preferable to remove the ozone as quickly as possible in the case of ozone production. In this embodiment, such ozone removal is realized by installing a fan 7 to be described later.

The fixing unit 6 is disposed downstream of the image forming unit 5 on the simplex printing conveyance path 3. The fixing unit 6 heats the recording sheet passing in the simplex printing conveyance path 3 after the toner image is formed thereon by the image forming unit 5, thereby fixing the transferred toner image to the recording sheet.

Hereinafter, a side of the simplex printing conveyance path 3 where the photoconductive drum 51 is disposed, i.e. a side of the simplex printing conveyance path 3 facing in +X direction shown in FIG. 2 is referred to as the front side of the simplex printing conveyance path 3, and the other side, i.e. a side facing in −X direction is referred to as the rear side of the simplex printing conveyance path 3. The image forming unit 5 and the fixing unit 6 form an image on the front side of a recording sheet being conveyed in the simplex printing conveyance path 3.

The pair of discharge rollers 31 are disposed downstream of the fixing unit 6 on the simplex printing conveyance path 3, more specifically on a most downstream part of the simplex printing conveyance path 3. The pair of discharge rollers 31 discharge the recording sheet conveyed to the position thereof along the simplex printing conveyance path 3 to the discharge unit 15 or conveys the recording sheet to the duplex printing conveyance path 4.

In the case of discharging the recording sheet to the discharge unit 15, the pair of discharge rollers 31 are driven in forward directions to introduce the recording sheet from the simplex printing conveyance path 3 to the discharge unit 15. On the other hand, in the case of conveying the recording sheet to the duplex printing conveyance path 4, the pair of discharge rollers 31 are stopped with the recording sheet nipped therebetween after conveying the recording sheet by a specified length in forward direction toward the discharge unit 15. Thereafter, the pair of discharge rollers 31 are driven in reverse directions, whereby the recording sheet is switched back to enter the duplex printing conveyance path 4.

A discharging/branching guide 32 is disposed between the fixing unit 6 and the pair of discharge rollers 31 in the simplex printing conveyance path 3. The upper end of the duplex printing conveyance path 4 is connected with the simplex printing conveyance path 3 at the arranged position of the discharging/branching guide 32. The discharging/branching guide 32 introduces the recording sheet conveyed thereto in the simplex printing conveyance path 3 via the fixing unit 6 to the pair of discharge rollers 31. On the other hand, if the pair of discharge rollers 31 reverse the conveying direction of the recording sheet to convey the recording sheet in a reverse direction to the position of the discharging/branching guide 32, the posture of the discharging/branching guide 32 is switched to convey the recording sheet conveyed in the reverse direction toward the duplex printing conveyance path 4. In this way, the discharging/branching guide 32 introduces the switched-back recording sheet to the duplex printing conveyance path 4.

The duplex printing conveyance path 4 has the upper end thereof connected with the simplex printing conveyance path 3 at the position of the discharging/branching guide 32 and extends substantially vertically downward therefrom at the rear side of the simplex printing conveyance path 3. The downstream end of the duplex printing conveyance path 4 is connected with a part of the simplex printing conveyance path 3 between the sheet feeding unit 12 and the image forming unit 5. The simplex printing conveyance path 3 and the duplex printing conveyance path 4 vertically extend side by side with the duplex printing conveyance path 4 located closer to the outer covering 19.

The apparatus main body 10 performs simplex printing through a simplex printing process as described below using the above respective constructions shown in FIGS. 2 and 3.

First of all, a recording sheet having an image thereon is introduced to the lower part of the simplex printing conveyance path 3 from any one of the sheet cassettes 122, 123 and the manual sheet feeder 121. The introduced recording sheet is conveyed upward in the simplex printing conveyance path 3, i.e. toward the downstream side of the simplex printing conveyance path 3. The recording sheet is successively introduced to the image forming unit 5 and the fixing unit 6 in the simplex printing conveyance path 3. When the recording sheet passes the nip portion 57 of the image forming unit 5, a toner image corresponding to a document image of a document read by the scanner unit 11 is transferred thereto. The recording sheet having the toner image transferred thereto is heated and the transferred toner image is fixed to the recording sheet by this heat when passing the fixing unit 6 disposed downstream of the image forming unit 5. The recording sheet having the toner image fixed thereto is conveyed to the position of the pair of discharge rollers 31 while being guided by the discharging/branching guide 32 in the simplex printing conveyance path 3. In this way, the recording sheet having the document image on one side of the document formed thereon is discharged to the discharge unit 15 by the pair of discharge rollers 31.

On the other hand, the apparatus main body 10 performs a duplex printing process as described below in the case of duplex printing. First of all, as in the above case of simplex printing, a recording sheet is introduced from the sheet feeding unit 12 to the position of the pair of discharge rollers 31 in the simplex printing conveyance path 3 to have an image formed on the top side of the recording sheet.

When the recording sheet finished with image formation on the top side arrives at the position of the pair of discharge rollers 31, the pair of discharge rollers 31 reverses the conveying direction of the recording sheet. By this reversing, the recording sheet is introduced to the duplex printing conveyance path 4 while being guided by the discharging/branching guide 32. The recording sheet introduced to the duplex printing conveyance path 4 is conveyed toward the downstream side in the duplex printing conveyance path 4. The recording sheet is introduced to the simplex printing conveyance path 3 again at the position between the sheet feeding unit 12 and the image forming unit 5 where the duplex printing conveyance path 4 is connected with the simplex printing conveyance path 3.

Upon being introduced to the simplex printing conveyance path 3 again, the recording sheet is conveyed second time toward the downstream side in the simplex printing conveyance path 3 to pass the image forming unit 5 and the fixing unit 6 again.

Here, the recording sheet is previously switched back at the position of the pair of discharge rollers 31 and is turned upside down when being introduced to the simplex printing conveyance path 3 again from the duplex printing conveyance path 4 as compared to its orientation when being introduced first time to the simplex printing conveyance path 3. Thus, the under side of the recording sheet is located at the front side of the simplex printing conveyance path 3, and an image is formed on the under side of the recording sheet by the image forming unit 5 and the fixing unit 6 when the recording sheet passes in the simplex printing conveyance path 3 again. When the recording sheet finished with image formation on the both sides is conveyed to the pair of discharge rollers 31 via the discharging/branching guide 32 in the simplex printing conveyance path 3, the pair of discharge rollers 31 discharge the recording sheet to the discharge unit 15.

The detailed structure of the exhaust ventilator 2 is described with reference to FIG. 3. The apparatus main body 10 includes the fan 7 and an air guiding member 7A between the simplex printing conveyance path 3 and the duplex printing conveyance path 4. The fan 7 and the air guiding member 7A are accommodated in the apparatus main body 10 together with the simplex printing conveyance path 3 and the duplex printing conveyance path 4 by the outer covering 19 of the apparatus main body 10.

The exhaust ventilator 2 includes the fan 7, the air guiding member 7A, a cover 21 and an ozone filter 212.

The fan 7 is disposed in the vicinity of the photoconductive drum 51 such that an air inlet 71 faces the simplex printing conveyance path 3 and an air outlet 72 faces the duplex printing conveyance path 4. By driving the fan 7, an air stream A is generated from the simplex printing conveyance path 3 toward the duplex printing conveyance path 4.

Wall surfaces forming the simplex printing conveyance path 3 and the duplex printing conveyance path 4 are formed with unillustrated vent holes serving as a flow path for the air stream A. By the fan 7, the air stream A flows through the vent hole of the wall surface of the simplex printing conveyance path 3 to reach the side of the simplex printing conveyance path 3 opposite to the fan 7, i.e. the front side of the simplex printing conveyance path 3. Similarly, by the fan 7, the air stream A flows through the vent hole of the wall surface of the duplex printing conveyance path 4 to reach the side of the duplex printing conveyance path 4 opposite to the fan 7, i.e. the side where the outer covering 19 is provided.

Thus, the air stream A gives a suction force acting toward the rear side of the simplex printing conveyance path 3 to the recording sheet being conveyed in the simplex printing conveyance path 3 at such a position as to cross the simplex printing conveyance path 3 through the vent holes of the simplex printing conveyance path 3.

Since the fan 7 is disposed in the vicinity of the photoconductive drum 51 and the charger 52, the air stream A flows through the vicinity of the photoconductive drum 51 and the charger 51 at a side upstream of the simplex printing conveyance path 3 on the flow path. Accordingly, the air stream A crosses the air in the vicinity of the photoconductive drum 51 and the charger 52 and the simplex printing conveyance path 3, goes through the fan 7 and moves toward the downstream side to cross the duplex printing conveyance path 4.

Thus, even if ozone is produced in the charger 52, the ozone is guided by the air stream A to forcibly move toward the cover 21. This can prevent the ozone from being adsorbed by the photoconductive drum 51.

The air guiding member 7A is a member for directing the air exhausted through the air outlet 72 of the fan 7 to form the air stream A toward a position where the cover 21 (see FIGS. 1 to 3) is disposed. In the duplex printing conveyance path 4, the vent holes are formed on the flow path of the air stream A directed toward the position of the cover 21.

FIG. 4 is a diagram showing the external appearance of the image forming apparatus 1 when viewed from the side facing in −X direction where the exhaust ventilator 2 is provided. FIG. 5 is a diagram enlargedly showing an essential part of the FIG. 4. The exhaust ventilator 2 includes the cover 21 (see FIG. 3) detachably mountable on the apparatus main body 10 and recessed portions 22 formed in the outer covering 19 of the apparatus main body 10 and provided with locking bars (not shown) engageable with hooks 213 of the cover 21.

The cover 21 includes the exhaust holes 211, the hooks 213 and the ozone filter 212 (see FIG. 3). The exhaust holes 211 cause the inside and outside of the apparatus main body 10 to communicate with the cover 21 mounted on the apparatus main body 10. Thus, the air stream A (see FIG. 3) having moved to the cover 21 is exhausted to the outside of the image forming apparatus 1 through the exhaust holes 211.

The ozone filter 212 is detachably attached to the cover 21 in such a manner as to close the exhaust holes 211 of the cover 21. As shown in FIG. 3, the ozone filter 212 is attached to a surface of the cover 21 facing the interior of the apparatus main body 10 with the cover 21 mounted on the apparatus main body 10. When the cover 21 having the ozone filter 212 attached thereto is mounted on the image forming apparatus 1, the air stream A exhausted to the outside of the image forming apparatus 1 through the exhaust holes 211 passes through the ozone filter 212.

The ozone filter 212 adsorbs the ozone contained in the air stream A to collect the ozone produced in the charger 52 when the ozone produced in the charger 52 is carried to the position of the ozone filter 212 by the air stream A. In this way, the ozone is removed from the air stream A passing through the ozone filter 212 and coming out of the image forming apparatus 1 through the exhaust holes 211, thereby cleaning the air in the air stream A.

The ozone filter 212 is, for example, a filter made of an activated carbon having a honeycomb structure. The width of the ozone filter 212 in the passage direction of the air stream A through the ozone filter 212, i.e. the width thereof in ±X directions in FIG. 3 is, for example, about 10 mm.

The hooks 213 are rotatably engaged with the unillustrated locking bars provided in the recessed portions 22 of the apparatus main body 10. With the hooks 213 engaged with the locking bars of the recessed portions 22, the cover 21 is rotated about the axial direction of the locking bars (±z directions) to be mounted on the apparatus main body 10. Conversely, in the case of detaching the cover 21 from the apparatus main body 10, the cover 21 is rotated in a direction opposite to the one at the time of mounting and the hooks 213 are disengaged from the locking bars of the recessed portions 22.

According to the image forming apparatus 1 described above, the following functions and effects can be obtained. To begin with, air exhausted through the air outlet 72 is introduced to the duplex printing conveyance path 4 by the air guiding member 7A by driving the fan 7 upon passing the recording sheet in the duplex printing conveyance path 4 at the time of duplex printing. The air guiding member 7A forms the air stream A at a position where air is blown to the recording sheet being conveyed in the duplex printing conveyance path 4. Thus, the recording sheet being conveyed in the duplex printing conveyance path 4 can be sufficiently cooled.

On the other hand, a suction force acting toward the rear side of the simplex printing conveyance path 3 along the flowing direction of the air stream A can be given to the recording sheet being conveyed in the simplex printing conveyance path 3 by the air stream A generated by the air suction of the fan 7 through the air inlet 71. In other words, since the air inlet 71 is so oriented as to face the vent hole (not shown) formed in the wall surface of the simplex printing conveyance path 3 facing toward the outer covering 19, the recording sheet can be sucked toward this wall surface.

This can stabilize the behavior of the recording sheet being conveyed in the simplex printing conveyance path 3 by causing the recording sheet to stably pass in the simplex printing conveyance path 3. Further, since pivotal movements of the recording sheet are suppressed, an occurrence of a problem of an image defect due to the abrasion of the toner image on the recording sheet, which is not yet fixed, with another member, e.g. the cleaning unit 55 can be prevented. Therefore, the recording sheet can be sufficiently cooled while obtaining a significant performance improvement worth the cost of providing the fan 7.

By sufficiently cooling the recording sheet in this way, the blurring of the toner on the hot recording sheet, for example, because of image formation on the under side of the recording sheet can be suppressed. Thus, the quality of the image formed on the under side of the recording sheet can be improved at the time of duplex printing. Further, a temperature increase in the apparatus and the deterioration of electronic parts due to the heat of the hot recording sheet can be suppressed.

In this embodiment, the simplex printing conveyance path 3 and the duplex printing conveyance path 4 extending in vertical direction are arranged side by side in horizontal direction. Accordingly, a space enabling the two conveyance paths, i.e. the simplex printing conveyance path 3 and the duplex printing conveyance path 4 to be aligned in vertical direction needs not be provided in the apparatus main body 10, with the result that the height of the image forming apparatus 1 can be reduced. In the case of adopting such so-called vertical conveyance, a stable state of conveyance of the recording sheet cannot be very much expected due to gravity. However, a suction force is given to the recording sheet being conveyed in the simplex printing conveyance path 3 and a pressing force created by the blowing of the cooling air is given to the recording sheet being conveyed in the duplex printing conveyance path 4, wherefore the state of conveyance of the recording sheet can be stabilized and the advantage of installing the fan can be further enjoyed.

Even if ozone is produced in the charger 52, this ozone is carried to the downstream side of the air stream A by the air stream A. The ozone is collected by the ozone filter 212 provided on the cover 21 at the most downstream position of the flow path of the air stream A. Therefore, even if the ozone is produced, it can be collected by the ozone filter 212 without leaking to the outside of the image forming apparatus 1.

In other words, the air in the image forming apparatus 1 can be discharged to the outside of the image forming apparatus 1 without the leakage of the ozone. Thus, when it is desired to cool the image forming unit 5 and its vicinity, the air in and around the image forming unit 5 can be properly discharged to the outside of the image forming apparatus 1 without the leakage of the ozone.

Further, the ozone filter 212 can be easily mounted at a suitable position in the apparatus main body 10 and can be properly protected by the cover 21 only by one operation of mounting the cover 21 on the apparatus main body 10. On the other hand, if the ozone filter 212 deteriorates to reduce its power for removing the ozone, the cover 21 is detached from the image forming apparatus 1. Then, after the deteriorated ozone filter 212 is detached from the detached cover 21 and a new ozone filter 212 is attached to the cover 21, the cover 21 is mounted on the image forming apparatus 1 again. Therefore, a state of sufficiently collecting the ozone by the new ozone filter 212 can be easily set again.

With such an image forming apparatus 1, the cover 21 can be easily attached to and detached from the apparatus main body 10 without using any tool by engaging and disengaging the hooks 211 with and from the locking bars of the recessed portions 22. Thus, for example, even general users who are not servicemen or the like can easily replace the ozone filter 212 by detaching and attaching the cover 21.

Since the ozone filter 212 is disposed downstream of the duplex printing conveyance path 4, it is possible to easily replace the ozone filter 212 without being hindered by the duplex printing conveyance path 4.

It should be noted that the ozone filter 212 may be disposed upstream of the duplex printing conveyance path 4 instead of being disposed at the side of the air stream A downstream of the duplex printing conveyance path 4. By doing so, the ozone can be collected from the air contained in the air stream A by the ozone filter 212 before the air stream A is partly diffused upon coming into contact with the duplex printing conveyance path 4 or the recording sheet passing in the duplex printing conveyance path 4, and most ozone can be reliably collected without escaping into the diffused air. The ozone filter 212 may be, for example, provided on the fan 7 or may be, for example, provided on at least one of the air inlet 71 and the air outlet 72 of the fan 7. By doing so, the ozone filter 212 can be supported on the fan 7, wherefore the construction of the image forming apparatus 1 can be simplified without requiring a separate supporting member for the ozone filter 212.

The specific embodiment described above mainly embraces inventions having the following constructions.

An image forming apparatus according to one aspect of the present invention comprises an image forming unit for applying an image transferring process to a sheet-like recording material; a fixing unit for applying a heat fixing process to the recording material after the image transferring process by the image forming unit; a first conveyance path for conveying the recording material via the image forming unit and the fixing unit; a second conveyance path for returning the recording material after the fixing process by the fixing unit to an upstream side of the image forming unit from a side of the first conveyance path downstream of the fixing unit in the case of applying the image transferring process to both sides of the recording material; and a fan disposed between the first and second conveyance paths for taking air across the first conveyance path and exhausting air across the second conveyance path to form an air stream.

According to this construction, the recording material being conveyed in the second conveyance path can be sufficiently cooled by blowing air thereto by the air stream crossing the second conveyance path. Further, a suction force acting in an air flowing direction can be given to the recording material being conveyed in the first conveyance path by the air stream crossing the first conveyance path. By causing the recording material to stably pass in the first conveyance path in this way, the behavior of the recording material being conveyed in the first conveyance path can be stabilized. Further, since pivotal movements of the recording material can be suppressed, an occurrence of a problem of an image defect due to the abrasion of a toner image on the recording material, which is not yet fixed, with another member can be prevented. Therefore, the recording material can be sufficiently cooled while obtaining a significant performance improvement worth the cost of providing the fan.

By sufficiently cooling the recording material being conveyed in the second conveyance path in this way, the blurring of the toner due to the high temperature of the recording material can be suppressed, for example, upon forming an image on the recording material returned to the first conveyance path. Thus, the quality of the image formed by the second image formation in duplex printing can be improved. Further, a temperature increase in the apparatus and the deterioration of electronic devices due to the heat of the recording material can be suppressed.

In the above construction, the first conveyance path and the second conveyance path preferably include parts for vertically conveying the recording material.

According to this construction, the first and second conveyance paths can be arranged side by side in horizontal direction. Thus, a space enabling the two conveyance paths, i.e. the first conveyance path and the second conveyance path to be aligned in vertical direction needs not be provided in the image forming apparatus, with the result that the height of the image forming apparatus can be reduced. In the case of adopting such so-called vertical conveyance, a stable state of conveyance of the recording material cannot be very much expected due to gravity. However, a suction force is given to the recording material being conveyed in the first conveyance path and a pressing force created by the blowing of the cooling air is given to the recording material being conveyed in the second conveyance path, wherefore the state of conveyance of the recording material can be stabilized and the advantage of installing the fan can be further enjoyed.

In the above construction, it is preferable that an outer covering for accommodating the image forming unit, the fixing unit, the first conveyance path, the second conveyance path and the fan is further provided; and that the vertically conveying parts of the first and second conveyance paths are arranged side by side in horizontal direction with the second conveyance path located closer to the outer covering.

In this case, it is preferable that the fan includes an air inlet and an air outlet and is disposed between the first and second conveyance paths; and that the air inlet faces toward the first conveyance path while the air outlet faces toward the second conveyance path.

According to this construction, a suction force for the recording material being conveyed in the first conveyance path and an air blow for the recording material being conveyed in the second conveyance path can be efficiently produced.

In the above construction, it is preferable that an air guiding member disposed between the first and second conveyance paths for guiding the air discharged from the air outlet in a specified direction is further provided; and that the air guiding member forms the air stream at a position where air is blown to the recording material being conveyed in the second conveyance path. According to this construction, air can be efficiently blown to the recording material by the air guiding member.

In the above construction, it is preferable that a vent hole formed in a wall surface of the first conveyance path facing the outer covering is further provided; and that the air inlet faces the vent hole to suck the recording material being conveyed in the first conveyance path toward the wall surface of the first conveyance path facing the outer covering.

In the above construction, it is preferable that a vent hole formed in a wall surface of the first conveyance path facing the outer covering and an air guiding member disposed between the first and second conveyance paths for guiding the air discharged from the air outlet in a specified direction are further provided; that the air inlet faces the vent hole to suck the recording material being conveyed in the first conveyance path toward the wall surface of the first conveyance path facing the outer covering; and that the air guiding member forms the air stream at a position where air is blown to the recording material being conveyed in the second conveyance path.

In the above construction, it is preferable that the image forming unit includes a photoconductive drum for transferring a toner image formed on the circumferential surface thereof to a recording material being conveyed in the first conveyance path and a charger for applying a charging voltage to the photoconductive drum; and that the fan is disposed in the vicinity of the photoconductive drum to form an air stream that flows through the vicinity of the photoconductive drum and the charger.

In the above construction, it is preferable that an ozone filter disposed in the flow path of the air stream is further provided; that the image forming unit includes a photoconductive drum for transferring a toner image formed on the circumferential surface thereof to a recording material being conveyed in the first conveyance path and a charger for applying a charging voltage to the photoconductive drum; and that the charger is disposed at an upstream side of the ozone filter in the flow path of the air stream.

A high charging voltage is applied to the photoconductive drum by the charger, for example, prior to the formation of an electrostatic latent image as a basis of a toner image on the circumferential surface, whereby the photoconductive drum is charged. When such a high voltage is generated in the charger, ozone may be produced from the charger in some cases. According to this construction, even if ozone is produced in the charger, this ozone is carried by the air stream flowing across the first conveyance path. Then, the ozone is collected by the ozone filter disposed in the flow path of the air stream. Therefore, even if ozone is produced, it can be collected by the ozone filter without leaking to the outside of the image forming apparatus.

In other words, the air in the image forming apparatus can be discharged to the outside of the image forming apparatus without the leakage of the ozone. Thus, when it is desired to cool the image forming unit and its vicinity, the air in and around the image forming unit can be properly discharged to the outside of the image forming apparatus without the leakage of the ozone.

In the above construction, it is preferable that an outer covering for accommodating the image forming unit, the fixing unit, the first conveyance path, the second conveyance path and the fan and a detachable cover formed with exhaust holes and provided at such a position as to exhaust the air stream having crossed the second conveyance path to the outside of the outer covering are further provided; and that the ozone filter is attached to the cover.

According to this construction, the ozone filter can be easily mounted and can be properly protected by the cover only by one operation of mounting the cover on the image forming apparatus. If the ozone filter deteriorates to reduce its power for removing the ozone, the cover is detached, the deteriorated ozone filter is detached and the cover having a new ozone filter attached thereto is mounted again, whereby a state of sufficiently collecting the ozone by the new ozone filter can be easily set again.

The cover is preferably formed, for example, as a hook-type cover so as to be mountable on the image forming apparatus without using any tool. By doing so, the ozone filter can be easily replaced and, for example, even general users who are not servicemen or the like can easily replace the ozone filter.

According to the image forming apparatus of the present invention described above, it is possible, at the time of duplex printing, not only to sufficiently cool the recording material whose temperature was increased by the image formation on one side and to stabilize the behavior of the recording material being conveyed in the first conveyance path. Therefore, a significant performance improvement worth the cost can be obtained.

This application is based on patent application No. 2007-091979 filed in Japan, the contents of which are hereby incorporated by references.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds are therefore intended to embraced by the claims.

What is claimed is:

1. An image forming apparatus, comprising:
an image forming unit for applying an image transferring process to a sheet-like recording material;
a fixing unit for applying a heat fixing process to the recording material after the image transferring process by the image forming unit;
a first conveyance path for conveying the recording material via the image forming unit and the fixing unit;
a second conveyance path for returning the recording material after the fixing process by the fixing unit to an upstream side of the image forming unit from a side of the first conveyance path downstream of the fixing unit in the case of applying the image transferring process to both sides of the recording material; and
a fan disposed between the first and second conveyance paths for taking air across the first conveyance path and exhausting air across the second conveyance path to form an air stream.

2. An image forming apparatus according to claim 1, wherein the first conveyance path and the second conveyance path include parts for vertically conveying the recording material.

3. An image forming apparatus according to claim 2, further comprising an outer covering for accommodating the image forming unit, the fixing unit, the first conveyance path, the second conveyance path and the fan, wherein the vertically conveying parts of the first and second conveyance paths are arranged side by side in horizontal direction with the second conveyance path located closer to the outer covering.

4. An image forming apparatus according to claim 3, wherein:
the fan includes an air inlet and an air outlet and is disposed between the first and second conveyance paths; and
the air inlet faces toward the first conveyance path while the air outlet faces toward the second conveyance path.

5. An image forming apparatus according to claim 4, further comprising an air guiding member disposed between the first and second conveyance paths for guiding the air discharged from the air outlet in a specified direction, wherein the air guiding member forms the air stream at a position where air is blown to the recording material being conveyed in the second conveyance path.

6. An image forming apparatus according to claim 4, further comprising a vent hole formed in a wall surface of the first conveyance path facing the outer covering, wherein the air inlet faces the vent hole to suck the recording material being conveyed in the first conveyance path toward the wall surface of the first conveyance path facing the outer covering.

7. An image forming apparatus according to claim 4, further comprising:
a vent hole formed in a wall surface of the first conveyance path facing the outer covering; and
an air guiding member disposed between the first and second conveyance paths for guiding the air discharged from the air outlet in a specified direction,
wherein:
the air inlet faces the vent hole to suck the recording material being conveyed in the first conveyance path toward the wall surface of the first conveyance path facing the outer covering; and
the air guiding member forms the air stream at a position where air is blown to the recording material being conveyed in the second conveyance path.

8. An image forming apparatus according to claim 1, wherein:
the image forming unit includes a photoconductive drum for transferring a toner image formed on the circumferential surface thereof to a recording material being conveyed in the first conveyance path and a charger for applying a charging voltage to the photoconductive drum; and
the fan is disposed in the vicinity of the photoconductive drum to form an air stream that flows through the vicinity of the photoconductive drum and the charger.

9. An image forming apparatus according to claim 1, further comprising an ozone filter disposed in the flow path of the air stream, wherein:
the image forming unit includes a photoconductive drum for transferring a toner image formed on the circumferential surface thereof to a recording material being conveyed in the first conveyance path and a charger for applying a charging voltage to the photoconductive drum; and
the charger is disposed at an upstream side of the ozone filter in the flow path of the air stream.

10. An image forming apparatus according to claim 9, further comprising:
an outer covering for accommodating the image forming unit, the fixing unit, the first conveyance path, the second conveyance path and the fan; and
a detachable cover formed with exhaust holes and provided at such a position as to exhaust the air stream having crossed the second conveyance path to the outside of the outer covering are further provided;
wherein the ozone filter is attached to the cover.
